(19) United States
(12) Patent Application Publication
(10) Pub. No.: US 2022/0218035 A1
(43) Pub. Date: Jul. 14, 2022

(54) Droplet Size Management through Vortex Generation

(71) Applicant: 2792684 ONTARIO INC., Inverhuron (CA)

(72) Inventor: Timothy SB Wong, Richmond Hill (CA)

(73) Assignee: 2792684 ONTARIO INC., Inverhuron (CA)

(21) Appl. No.: 17/146,884

(22) Filed: Jan. 12, 2021

(51) Int. Cl. A24F 40/48; A24F 40/10; B01D 45/16; B01D 45/14; A24F 40/44

(52) U.S. Cl. CPC A24F 40/48; A24F 40/10; A24F 40/44; B01D 45/14; B01D 45/16

(57) ABSTRACT

A vortex generator in the air flow path, within a pod for use with a vaporizer, interrupts laminar air flow to create a vortex within the air flow, allowing entrained droplets above of threshold size to be favorably removed from the air flow. The creation of a vortex modifies the air flow path to include turns, which are somewhat resisted by droplets having larger size and thus a higher momentum. As the droplets above a threshold size rotate in the vortex, they have an increased likelihood to be pushed out of the airflow and into the walls of a post wick air flow passage, whereby they are removed from the airflow.

### CROSS REFERENCE TO RELATED APPLICATIONS

This is the first application for the instant invention.

### TECHNICAL FIELD

This application relates generally to managing the size of droplets in an airflow, and more particularly to a mechanism for removing droplets above a threshold size for use in conjunction with an electronic cigarette or vaporizer.

### BACKGROUND

Electronic cigarettes and vaporizers are well regarded tools in smoking cessation. In some instances, these devices are also referred to as an electronic nicotine delivery system (ENDS). A nicotine based liquid solution, commonly referred to as e-liquid, often paired with a flavoring, is atomized in the ENDS for inhalation by a user. In some embodiments, e-liquid is stored in a cartridge or pod, which is a removable assembly having a reservoir from which the e-liquid is drawn towards a heating element by capillary action through a wick. In many such ENDS, the pod is removable, disposable, and is sold pre-filled.

In some ENDS, a refillable tank is provided, and a user can purchase a vaporizable solution with which to fill the tank. This refillable tank is often not removable, and is not intended for replacement. A fillable tank allows the user to control the fill level as desired. Disposable pods are typically designed to carry a fixed amount of vaporizable liquid, and are intended for disposal after consumption of the e-liquid. The ENDS cartridges, unlike the aforementioned tanks, are not typically designed to be refilled. Each cartridge stores a predefined quantity of e-liquid, often in the range of 0.5 to 3 ml. In ENDS systems, the e-liquid is typically composed of a combination of any of vegetable glycerine, propylene glycol, nicotine and flavorings. In systems designed for the delivery of other compounds, different compositions may be used.

In the manufacturing of the disposable cartridge, different techniques are used for different cartridge designs. Typically, the cartridge has a wick that allows e-liquid to be drawn from the e-liquid reservoir to an atomization chamber. In the atomization chamber, a heating element in communication with the wick is heated to encourage aerosolization of the e-liquid. The aerosolized e-liquid can be drawn through a defined air flow passage towards a user's mouth.

FIGS. 1A, 1B and 1C provide front, side and bottom views of an exemplary pod 50. Pod 50 is composed of a reservoir 52 having an air flow passage 54, and an end cap assembly 56 that is used to seal an open end of the reservoir 52. End cap assembly has wick feed lines 58 which allow e-liquid stored in reservoir 52 to be provided to a wick (not shown in FIG. 1). To ensure that e-liquid stored in reservoir 52 stays in the reservoir and does not seep or leak out, and to ensure that end cap assembly 56 remains in place after assembly, seals 60 can be used to ensure a more secure seating of the end cap assembly 56 in the reservoir 52. In the illustrated embodiment, seals 60 may be implemented through the use of o-rings.

As noted above, pod 50 includes a wick that is heated to atomize the e-liquid. To provide power to the wick heater, electrical contacts 62 are placed at the bottom of the pod 50. In the illustrated embodiment, the electrical contacts 62 are illustrated as circular. The particular shape of the electrical contacts 62 should be understood to not necessarily germane to the function of the pod 50.

Because an ENDS device is intended to allow a user to draw or inhale as part of the nicotine delivery path, an air inlet 64 is provided on the bottom of pod 50. Air inlet 64 allows air to flow into a pre-wick air path through end cap assembly 56. The air flow path extends through an atomization chamber and then through post wick air flow passage 54.

FIG. 2A illustrates a cross section taken along line A in FIG. 1B. This cross section of the device is shown with a complete (non-sectioned) wick 66 and heater 68. End cap assembly 56 resiliently mounts to an end of air flow passage 54 in a manner that allows air inlet 64 to form a complete air path through pod 50. This connection allows airflow from air inlet 64 to connect to the post air flow path through passage 54 through atomization chamber 70. Within atomization chamber 70 is both wick 66 and heater 68. When power is applied to contacts 62, the temperature of the heater increases and allows for the volatilization of e-liquid that is drawn across wick 66.

Typically the heater 68 reaches temperatures well in excess of the vaporization temperature of the e-liquid. This allows for the rapid creation of a vapor bubble next to the heater 68. As power continues to be applied the vapor bubble increases in size, and reduces the thickness of the bubble wall. At the point at which the vapor pressure exceeds the surface tension the bubble will burst and release a mix of the vapor and the e-liquid that formed the wall of the bubble. The e-liquid is released in the form of aerosolized particles and droplets of varying sizes. These particles are drawn into the air flow and into post wick air flow passage 54 and towards the user.

FIG. 2B shows a cross section of pod 50 along section line B as shown in FIG. 2A. Between end cap assembly 56 and reservoir 52 is shown o-ring 60 which provides a seal and prevents removal of the end cap assembly 56. Post-wick air flow passage 54 is centrally located, and flanked on either side by wick feed lines 58.

FIG. 3 is an illustration of an airflow in a pod 50. Air enters from air inlet 64, and progresses through to atomization chamber 70 which houses wick 66. Air flow 72 curves around wick 66 in atomization chamber 70 and entrains droplets and aerosols expelled by the heating of wick 66. The airflow 72 proceeds into post-wick air flow passage 54 as airflow 74 which typically proceeds towards the user as a laminar air flow.

User experience of an ENDS is related to a number of factors including the delivery of nicotine and the flavor compounds in the e-liquid. The size of the droplets entrained by the airflow, after the bubble pops, is associated with a number of different experiences. Flavor compounds are best experienced by smaller particle sizes. Larger particles are less likely to impart flavour, and are associated with other negative experiences including an effect referred to as spitback.

Spitback is a term used to refer to the result of a large particle being entrained in the air flow and delivered with high velocity to the user. In different applications and different devices, there is a droplet threshold above which droplets are known to be associated with user complaints about spitback. In one example, in an ENDS device, droplets over 5 μm in diameter are typically considered to be the cause of user complaints about spitback. This threshold may vary from device to device. The mitigation of spitback can be achieved through the control of the size of the droplets entrained in the air flow.

In some conventional ENDS, a mouthpiece that sits atop the pod 50 can be used to modify the path of the airflow exiting air flow passage 54. Because the droplets in questions are larger droplets, they tend to have greater momentum than the more desirable droplets. By controlling the placement of apertures in the mouthpiece, larger droplets can be kept from ingestion by the user. The laminar air flow 74 in passage 54 will typically direct larger droplets in a straighter air flow. If the mouthpiece has air flow holes placed away from the center of air flow passage 54, larger droplets will typically not be passed through to the user.

With some ENDS that make use of a user activated switch to power the heater in place of a pressure sensor, users are recommended to not power on the heater until after the user starts drawing on the device, or to reduce the power provided to the heater.

Each of these techniques may have some effect on the presence of spitback, however none of these techniques have been successful in completely eliminating spitback, which remains a problem to many users.

It would therefore be beneficial to have a mechanism to further mitigate spitback.

### SUMMARY

It is an object of the aspects of the present invention to obviate or mitigate the problems of the above-discussed prior art.

The above discussed droplet size related problems can be addressed by either preventing the creation of droplets above a certain threshold, or by removing those droplets from the air flow. Because the droplets are created during the atomization of e-liquid at the heater and wick, removal of the droplets can be performed in the post wick air flow passage. Instead of filtering using a mechanical filter, droplets can be removed by directing them into the wall of the post wick air flow passage. Because it is larger droplets that should be removed, the dynamics of the air flow within the post wick air flow passage can be used to aid in the removal of these droplets. It should be understood that complete removal of all droplets above a threshold size may not be possible, but the reduction in the number of droplets above the threshold will still materially improve the user experience. To preferentially remove the droplets, a vortex within the post wick air flow path can be created. As droplets follow a rotating path, their direction of motion is constantly changing. Larger droplets moving at the same or similar velocity as a smaller droplet will have a greater momentum as a result of their greater mass. This will result in the larger droplets being pushed towards the outer edge of a vortex. This effect can be used to push the larger droplets towards the wall of the post wick air flow passage, which will increase the likelihood that they will make contact with the wall and be removed from the airflow.

The size, location and shape of the vortex generator will determine many of the characteristics of the generated vortex. Different size droplets have different impacts on user experience. While large droplets are typically associated with a poor user experience, certain sizes of smaller droplets are associated with the delivery of different flavors. The selection of vortex generator physical characteristics may impact on delivery of flavor. The size, placement, and shape of the vortex generator is to a large extent a function of the acceptable droplet size, the amount of flavor reduction that is acceptable, the geometry of the pod structures and the make up of the e-liquid.

In a first aspect there is provided a pod for storing an atomizable liquid. The pod comprises a reservoir, a wick, and a vortex generator. The reservoir is for storing the atomizable liquid, and is in fluid communication with the wick. The wick draws the atomizable liquid from the reservoir into an atomization chamber. The atomization chamber is within an air flow path defined within the pod. The vortex generator is located within the air flow path. The vortex generator is configured to interrupt laminar air flow within the path, and generates a vortex in a post wick air flow passage.

In some embodiments of the first aspect, the wick draws the atomizable liquid stored within the reservoir through capillary action. The post wick air flow passage defines a portion of the air flow path after the air flow has passed through the atomization chamber. The air flow passage may further comprise a pre-wick air flow passage through which the air flow passes before it enters the atomization chamber. In some embodiments, the liquid is an e-liquid comprising at least one of propylene glycol, vegetable glycerin, nicotine and a flavoring.

In some embodiments, the post wick air flow passage is configured such that an airflow passing through the post wick air flow passage comprises droplets of the atomizatable liquid entrained within the air flow. Optionally, the post wick air flow passage is configured such that an airflow comprising droplets of the atomizable liquid forms at least one vortex within the post wick air flow passage. Characteristics of the vortex may be a function of the vortex generator, and the vortex generator may be configured to generate as vortex having characteristics that will preferentially remove droplets entrained in the airflow that are above a threshold size. This threshold size may optionally be determined in accordance with physical characteristics of the vortex generator.

In some embodiments, the vortex generator is one of a cylinder, a rectangular rod and a set of blades. As a function of the shape of the vortex generator, the airflow carried within the post wick air flow passage may comprise a Kàrmàn street vortex.

In another embodiment, the vortex generator is located within the post wick air flow passage. The vortex generator may be located near the interface between the atomization chamber and the post wick air flow passage. In some embodiments, the vortex generator is a feature defined within a resilient top cap which is optionally formed of silicone. In some embodiments, the vortex generator is rotated around a central axis of the post wick air flow passage with respect to the wick. In another embodiment, the vortex generator is parallel to the wick.

### BRIEF DESCRIPTION OF THE DRAWINGS

Various embodiments will now be described in detail by way of example only with reference to the following drawings in which like elements are described using like reference numerals to the greatest extent possible:

FIG. 1A illustrates a front plan view of a prior art pod;

FIG. 1B illustrates a side plan view of the pod of FIG. 1A;

FIG. 1C illustrates a bottom plan view of the pod of FIG. 1A;

FIG. 2A illustrates a cross section along section line A in FIG. 1B;

FIG. 2B illustrates a cross section along section line B in FIG. 1A and FIG. 2A;

FIG. 3 illustrates an example of an airflow in a prior art pod;

FIG. 4 illustrates an example of an airflow in a pod according to an embodiment of the present invention;

FIG. 5A illustrates a cross section of a pod having a vortex generation rod according to an embodiment of the present invention along section line A in FIG. 5B;

FIG. 5B illustrates a side view of a pod of the present embodiment having a vortex generation rod;

FIG. 5C illustrates a cross section of a pod having a vortex generation rod according to an embodiment of the present invention along section line B in FIG. 5A;

FIG. 6A illustrates a cross section of a pod having a vortex generation bar according to an embodiment of the present invention along section line A in FIG. 6B;

FIG. 6B illustrates a side view of a pod of the present embodiment having a vortex generation bar;

FIG. 6C illustrates a cross section of a pod having a vortex generation bar according to an embodiment of the present invention along section line B in FIG. 6A;

FIG. 7A illustrates a cross section of a pod having a vortex generator according to an embodiment of the present invention along section line A in FIG. 7B;

FIG. 7B illustrates a side view of a pod of the present embodiment having a vortex generator;

FIG. 7C illustrates a cross section of a pod having a vortex generation feature according to an embodiment of the present invention along section line B in FIG. 7A;

FIG. 8 illustrates a cross section of a pod according to an embodiment of the present invention;

FIG. 9 illustrates an alternate embodiment of the pod of FIG. 5A;

FIG. 10 illustrates an alternate embodiment of the pod of FIG. 5A;

FIG. 11A illustrates a cross section of a pod having a vortex generation rod according to an embodiment of the present invention along section line A in FIG. 11B;

FIG. 11B illustrates a side view of a pod of the present embodiment having a vortex generation rod; and

FIG. 11C illustrates a cross section of a pod having a vortex generation rod according to an embodiment of the present invention along section line B in FIG. 11A.

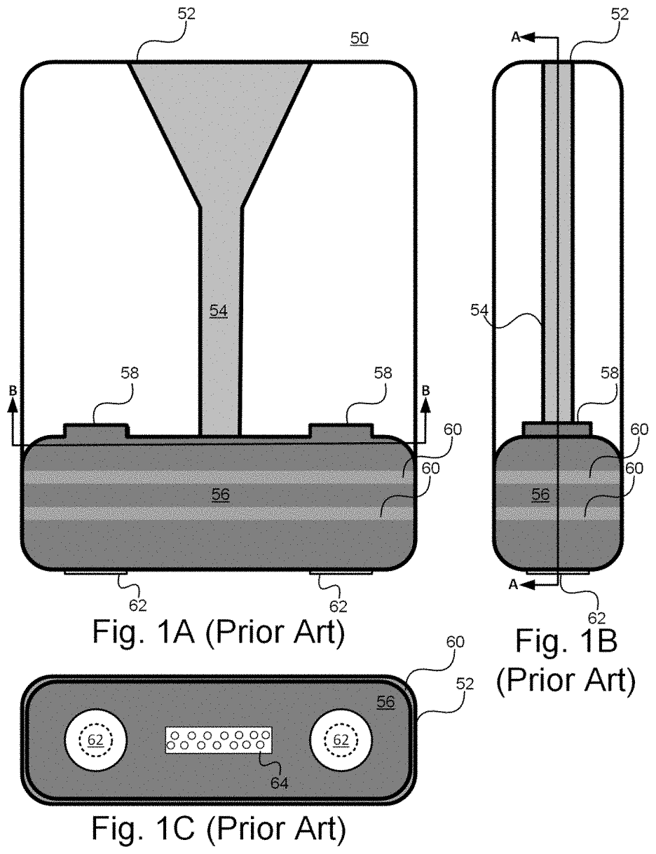

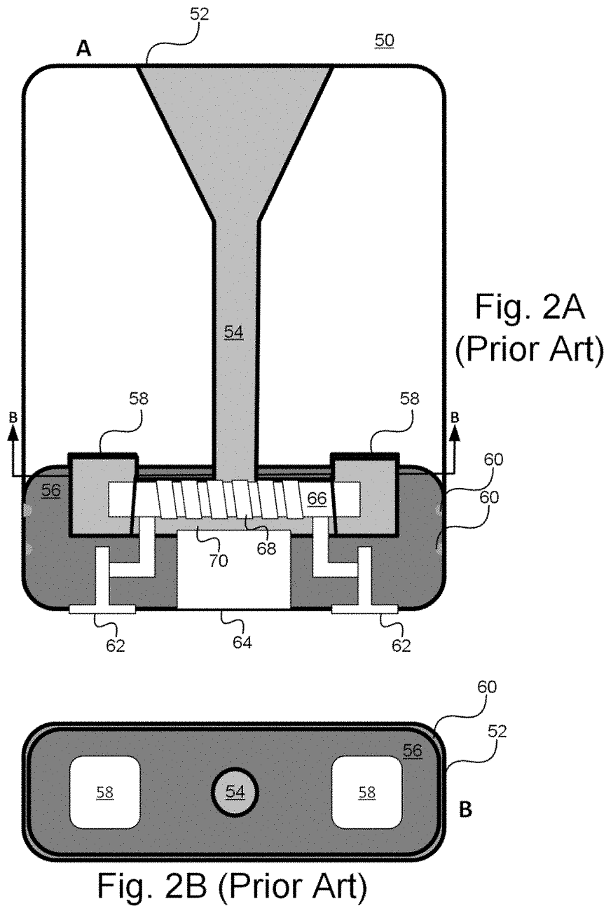

### DETAILED DESCRIPTION

In the instant description, and in the accompanying figures, reference to dimensions may be made. These dimensions are provided for the enablement of a single embodiment and should not be considered to be limiting or essential. Disclosure of numerical range should be understood to not be a reference to an absolute value unless otherwise indicated. Use of the terms about or substantively with regard to a number should be understood to be indicative of an acceptable variation of up to ±10% unless otherwise noted.

Although presented below in the context of use in an electronic nicotine delivery system such as an electronic cigarette (e-cig) or a vaporizer (vape) it should be understood that the scope of protection need not be limited to this space, and instead is delimited by the scope of the claims. Embodiments of the present invention are anticipated to be applicable in areas other than ENDS, including (but not limited to) other vaporizing applications.

As discussed above, when a user draws on an ENDS air flow is pulled across the length of the pod. Typically an air inlet is aligned with both the heater/wick and the post-wick air flow passage. This can be considered as an alignment of three elements, a pre-wick air flow passage (at or near the inlet), the atomization chamber (housing the heater and wick) and a post-wick air flow passage (extending from the atomization chamber to an end of the pod). The placement of the inlet, and the beginning of the atomization chamber will define the size and shape of the pre-wick air flow passage. When a user draws on the device (inhales through the device), an air flow is created through this combined air flow path. As noted above, the flow is typically laminar. This results in the droplets (of all sizes) created by the heater being entrained in a laminar air flow through the post wick air flow passage. The large droplets are known to be associated with spitback, and mitigation of spitback can be provided by removing droplets, above a defined size threshold, from the post-wick air flow passage.

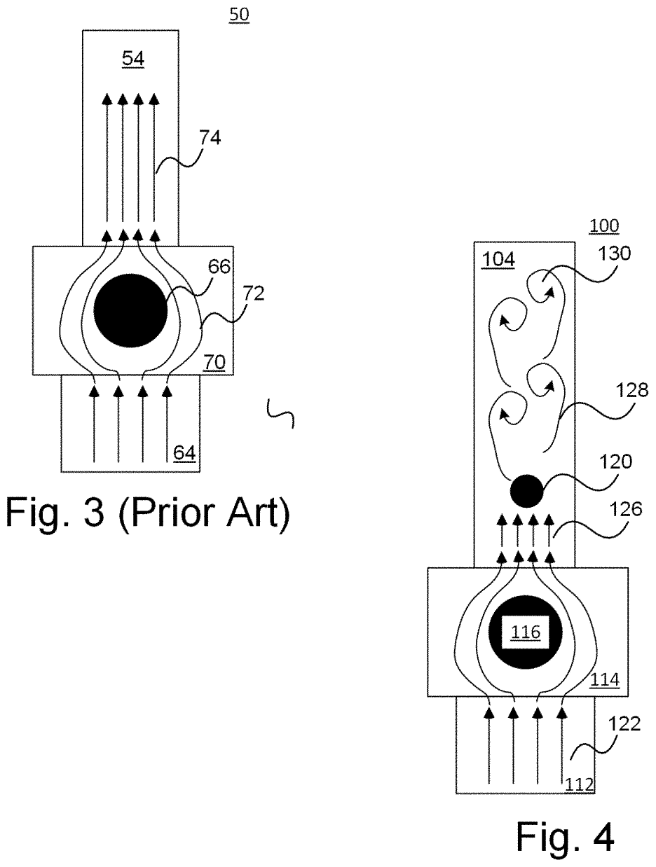

FIG. 4 illustrates a similar air flow passage configuration as shown in FIG. 3. However, in pod 100, an additional element is added to the overall air flow passage. A pre-wick air flow passage 112 allows for air intake, typically through an inlet as previously illustrated.

Pre-wick air flow passage 112 connects to atomization chamber 114 which houses wick 116, which in turn connects to post-wick air flow passage 104. Within pre-wick air flow passage 112 a laminar air flow 122 is generated as a result of a user drawing on the device. This laminar air flow 122 enters atomization chamber 114 and passes around wick 116 while remaining a laminar flow 124. The laminar nature of flow 124 is a result of the size of wick 116 with respect to the overall air flow passage. A wick 116 that is sufficiently large allows for a gentle disruption in the air flow 124. This allows air flow 124 to remain relatively laminar. Air flow 124 entrains droplets and vapor caused by powering the heater associated with wick 116. As air flow 124 enters air flow passage 104 it remains laminar in nature as such by air flow 126. Above the wick 116 (and shown here as oriented to be parallel with wick 116) is a vortex generator 120. Vortex generator 120 is sized in accordance with the width of air flow passage 104, and the size of droplets to be removed from air flow 126. As air flow 126 passes over vortex generator 120, the air flow becomes less steady and vortices are generated. This disrupts the laminar nature of air flow 126. The resulting air flow 128 is no longer laminar, with one or more vortices 130 being generated. With the air flow 128 forming vortices 130, droplets will follow a rotating air path 128 as they rise through air flow passage 104. It should be understood that the impact of a vortex generator 120 on the airflow 128 in the post wick air flow passage 104 will depend, at least to some extent, on the nature of the particular vortex generator 120. For vortex generators such as a rectangular bar or a cylinder, the air flow will experience an unsteady separation of flow. This will take the form of vortex shedding as vortices 130 form at the back end (the end furthest away from the wick) of the feature. The resulting form of the airflow 128 is often referred to as a Kàrmàn vortex street. This will result in vortices 130 of alternating orientations being shed from the feature 120. As these vortices 130 progress further from the feature 120, they may become larger in diameter. The effect of the vortices on the larger droplets in the air flow 128 is that as a result of their larger size and mass, larger droplets escape from the vortices.

Each droplet entrained in air flow 128 will carry a momentum determined in accordance with its size. The momentum of a droplet will affect the ability of the droplet to turn along with the vortex 130 that it is entrained within. By selecting the location of the vortex generator 120 with respect to the wick as well as the size and shape of the vortex generator 120, the characteristics of the resulting vortices 130 can be controlled. The location, size and shape of the vortex generator 120 may be considered as physical characteristics of the generator 120. By controlling the characteristics of the vortices 130, such as the pitch or turning radius, it is possible to create a vortex 130 that will keep droplets, below a threshold size, entrained, while droplets larger than the threshold will be “pushed” out of the vortex. In some embodiments, a vortex generator 120 taking the form of a rectangular bar or cylindrical rod would be located within the post wick air flow passage 104 at a distance from the wick that is between 2× and 5× the diameter of the channel, and the width of such a vortex generator 120 would be between 20 and 40% of the width of the channel 104. In some embodiments the diameter of post wick air flow passage 104 may range from 2 mm to 3 mm. It should be understood that the particular size of the post wick air flow passage 104 is implementation dependent and should not be considered as limiting. For a sufficiently large channel, the width of the feature could be larger, but in the context of an ENDS system, this is not as likely. Droplets over the threshold size carry sufficient momentum to prevent them from tightly following the path of the vortex 130. Because a larger droplet will typically move with a larger turning radius, it will be directed out of the vortex 130 and into the wall of the post wick air flow passage 104. This allows for removal of larger droplets from the airflow 128 by pushing them into the wall of air flow passage 104. After colliding with air flow passage wall 104, if a droplet is re-entrained into airflow 128, it is still subject to the same forces as before and will most likely be pushed into the air flow passage wall 104 at a different location. As a user drawing on the device is a time limited process, it is unlikely that the largest droplets will be able to be removed, re-entrained, removed again, etc. enough times to reach the user.

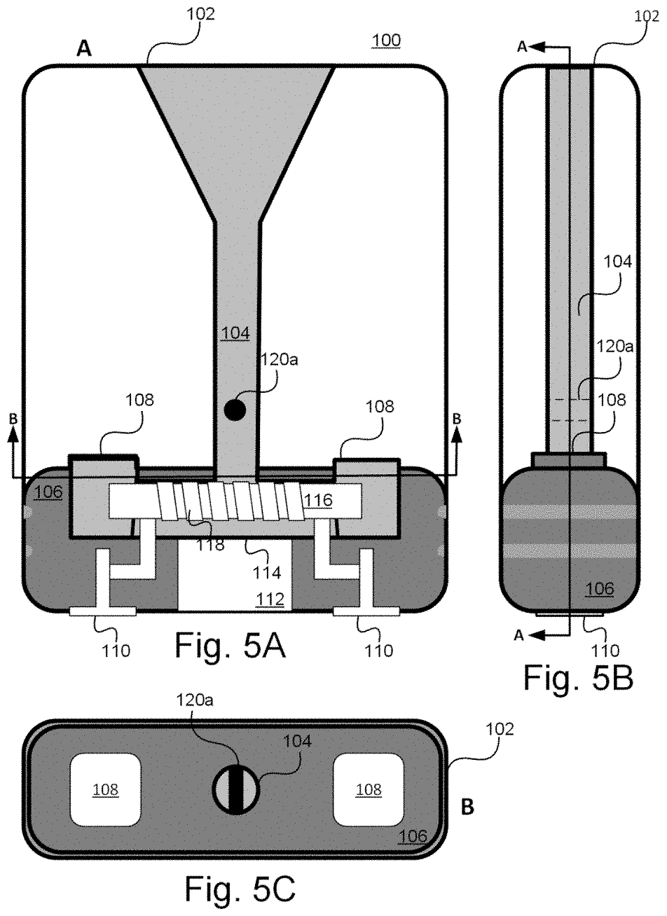

In the context of a complete pod 100, FIG. 5B shows a side view of a pod 100, FIG. 5A shows a cross section along section line A in FIG. 5B, while FIG. 5C shows a section along section line B. Pod 100 is comprised of a reservoir 102 having an air flow passage 104, and an end cap assembly 106. End cap assembly 106 defines a pair of wick feed lines 108 through which e-liquid 108 can move from the reservoir 102 to the wick 116. End cap assembly 106 allows for a connection between electrical contacts 110 with heater 118 which is wrapped around wick 116. Pre-wick air flow passage 112 may have an inlet as shown in the prior art figures above. Pre-wick air flow passage 112 connects to atomization chamber 114, which in turn connects to post-wick air flow passage 104. Within post-wick air flow passage 104 is the vortex generator 120a. As shown in FIGS. 5A-C, vortex generator 120a is a cylindrical rod located a defined distance above, level with and perpendicular with the wick 116. The illustrated positioning of vortex generator 120a is centered and level within post-wick air flow passage 104. Those skilled in the art will appreciate that vortex generator 120a could be located off center in other embodiments, and in some it may be angled from level with respect to the wick 116. In further embodiments, the vortex generator 120a need not fully extend across post-wick air flow passage 104, as will be illustrated in more detail with respect to other embodiments.

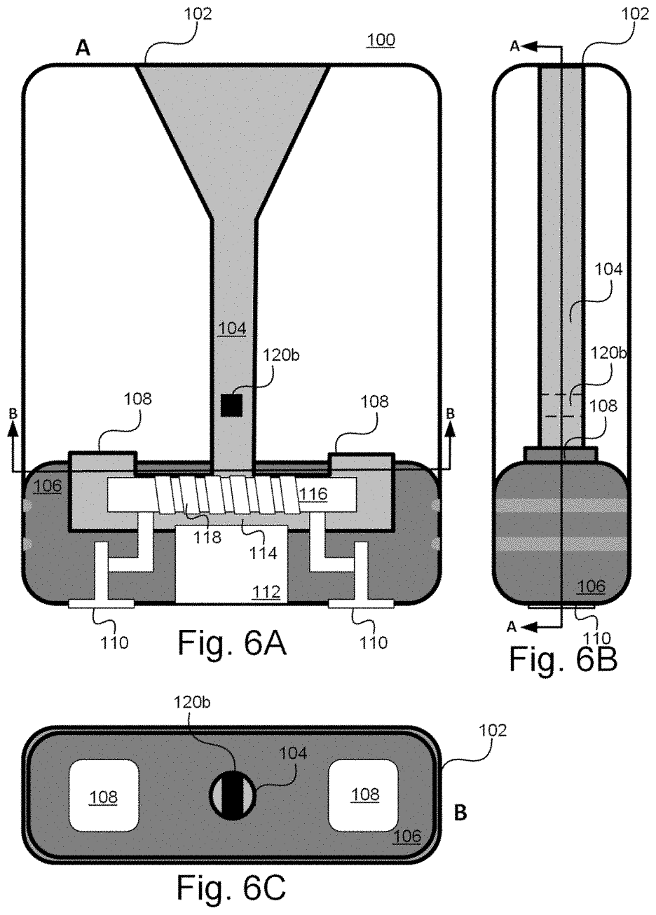

FIGS. 6A, 6B and 6C show an alternate embodiment of pod 100. Pod 100 is as described above with respect to FIGS. 5A, 5B and 5C, but in this illustrated embodiment, vortex generator 120b is shown as being a rectangular box shape. Again, although illustrated as fully extending through post-wick air flow passage 104, being level and perpendicular with respect to wick 116, none of these characteristics is required. In varying embodiments, the vortex generator 120b may be at least one of: inclined with respect to the wick 116; in line with wick 116; rotated from alignment with wick 116; and extend only partially across post-wick air flow passage 104.

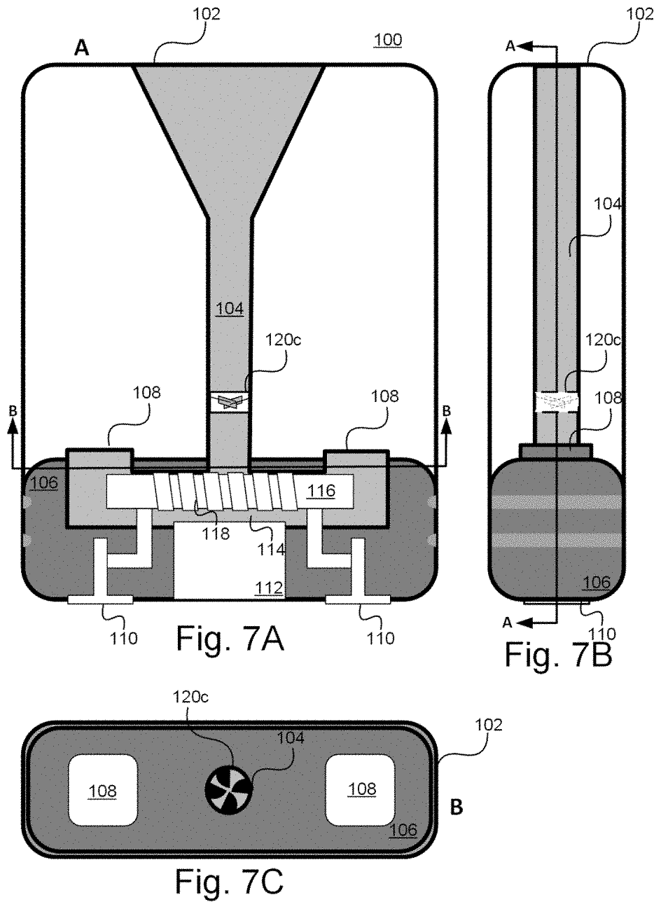

FIGS. 7A, 7B and 7C show an alternate embodiment of pod 100. Pod 100 is as described above with respect to FIGS. 5A, 5B and 5C, but in this illustrated embodiment, vortex generator 120c is shown as being a set of blades. Blades 120c are radially arranged around the circumference of post-wick air flow passage 104. The blades may be perpendicular to the wall of post-wick air flow passage 104, or they may be arranged at an angle with respect to it. It should be understood that with respect to FIG. 7A, the blades 120c may be inclined with respect to a central axis of the post wick air flow passage 104, and they may also be rotated from a horizontally perpendicular placement. The blades 120c may be rectangular, or they may be curved on at least one side. When viewed along the central axis of the post wick air for passage 104 the blades will have a substantially perpendicular component to the central axis as shown in FIG. 7C. Although shown in FIGS. 7A 7B and 7C, as substantially identical, in some embodiments blades in the set of blades 120c need not be identical to each other. With respect to the set of blades, the position, angle, and size of each blade (which may be identically configured) can form the physical characteristics of the vortex generator 120c.

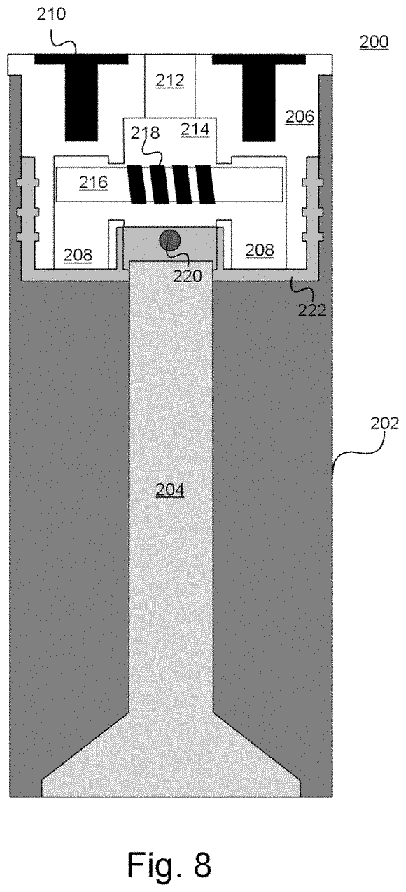

FIG. 8 illustrates an alternate configuration of a pod 200. Pod 200 comprises reservoir 202 having a post-wick air flow passage 204, and an end cap assembly 206. End cap assembly 206 includes wick feed lines 208, electrical contacts 210, an air inlet forming a pre-wick air flow passage 212, an atomization chamber 214 housing wick 216 and heater 218 (which is connected to electrical contacts 210). To seal end cap assembly 206 with reservoir 202, so that e-liquid cannot cannot leak or seep out of reservoir 202, and to keep end cap assembly 206 mounted within reservoir 202, and in place of the previously described O-ring, is a resilient cover or top cap 222. Resilient top cap 222 may be formed of any number of different reliant materials including silicone.

Vortex generator 220 can be formed in top silicone 222 instead of being placed within post-wick air flow passage 204. The geometry of end cap assembly 206 and resilient top cap 222 can be arranged to ensure that the distance between wick 216 and vortex generator 220 is sufficient to allow the air flow to resume its laminar flow before impacting upon vortex generator 220. As in previous embodiments, although illustrated as being each of extending the full length of the aperture in the resilient top cap 222, being perpendicular to the wick 216, and being perpendicular to the surface of post-wick air flow passage 204, it should be understood that different embodiment may not have one or more of these characteristics.

It should be understood that the vortex generator (which may be characterized as a vortex generation feature) needs to be a part of the air flow path, and in the illustrated embodiments it is placed after the wick in the air path flow. It does not need to be a part of the post-wick air flow passage (104, 204), nor does it necessarily need to be molded into an element such as the top silicone sleeve 222.

In some embodiments, a vortex generator may be formed as a separate element to be placed in line with an atomization chamber and post-wick air flow passage. An element in line with post-wick air flow passage that mated with post-wick air flow passage and the atomization chamber so as to form a sealed air flow path could be used as the vortex generator. Thus, a vortex generator could also be provided by a discrete element distinct within an air flow passage. The discrete element may locate the vortex generator in the post-wick portion of the air flow path. Those skilled in the art will further appreciate that although illustrated as being substantially centered with respect to a central axis of the post wick air flow passage, any embodiment of the vortex generators illustrated and discussed can be offset from the central axis.

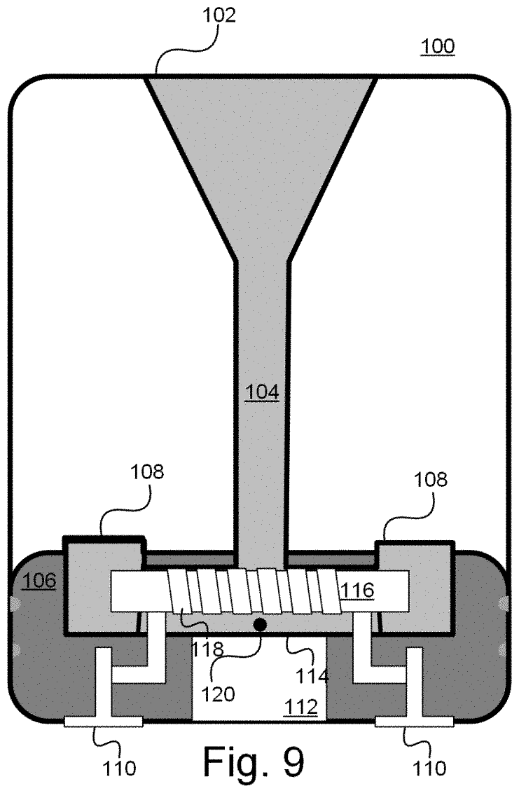

FIG. 9 illustrates an alternate embodiment of pod 100 in which the placement of the vortex generator 120 is changed from the embodiment of FIG. 5A. FIG. 9 illustrates pod 100 in a similar manner to that of FIG. 5A. However, in place of a vortex generator in post wick air flow passage 104, the vortex generator 120 is below the wick 116. Vortex generator 120 is used to create vortices in the post wick air flow passage 104, but it does not need to reside within the post wick airflow passage 104. In the illustrated embodiment of FIG. 9, the vortex generator is placed below wick 116 (and is shown here as being perpendicularly aligned with wick 116). Air flow from pre-wick air flow passage 112, which is typically laminar in nature, enters atomization chamber 114 and will encounter vortex generator 120. The bluff surface will result in the creation of a set of vortices above the generator 120, ensuring that the airflow within post wick air flow passage 104 contains vortices. The airflow within atomization chamber 114 will be determined by the relative placement of the vortex generator 120 and wick 116. Placing these two features close enough to each other can result in the air flow over wick 116 remaining relatively laminar, as the vortices only become more pronounced in the post wick air flow passage 104. Those skilled in the art will appreciate that the spacing between these elements to maintain such a flow may be a function of the relative size differences of the elements and the size of other elements such as the atomization chamber.

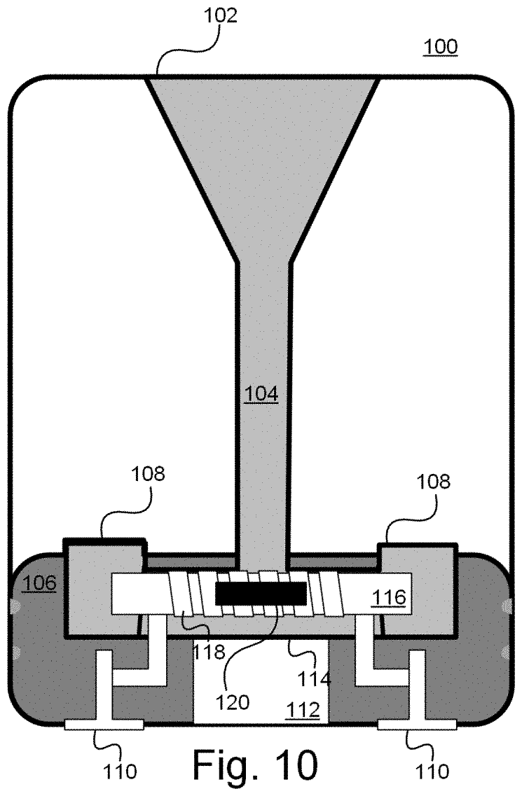

FIG. 10 illustrates a further alternate embodiment of pod 100 in which the placement of the vortex generator 120 differs from the placements shown in FIG. 5A and FIG. 9. In this illustrated embodiment, vortex generator 120 is placed parallel to wick 116 within atomization chamber 114. In some embodiments a vortex generator 120 may be placed on either side of wick 116, while in others only one vortex generator is employed. Where typically wick 116 is centered within an axis defined by the overall air flow within pod 100, wick 116 may be placed off center in the current embodiment to ensure that sufficient air flow is directed towards vortex generator 120. As with the embodiment of FIG. 9, the placement of vortex generator 120 in FIG. 10 is directed at creating vortices in the post wick air flow passage 104. In this embodiment the parallel placement of vortex generator 120 to wick 116 may not result in vortices near wick 116, but instead may result in a distinct air flow path through atomization chamber 114 for each of wick 116 and vortex generator 120, with the resulting air flows mixing in post wick air flow passage 104. The mixed air flow will include vortices to aid in the removal of droplets above a size determined by the features of vortex generator 120.

With respect to the embodiments of FIGS. 9 and 10, it should be understood that the size and other characteristics of the vortices generated as a result of vortex generator 120 may differ from the vortices generated by the vortex generator 120a placed within the post wick air flow passage 104 in FIG. 5A. The characteristics of the vortices created by the vortex generators 120 of FIGS. 9 and 10 can be modelled so that the threshold droplet size can be set. It should be understood that the size, orientation and placement of the vortex generator can be used to determine the threshold droplet size as discussed above.

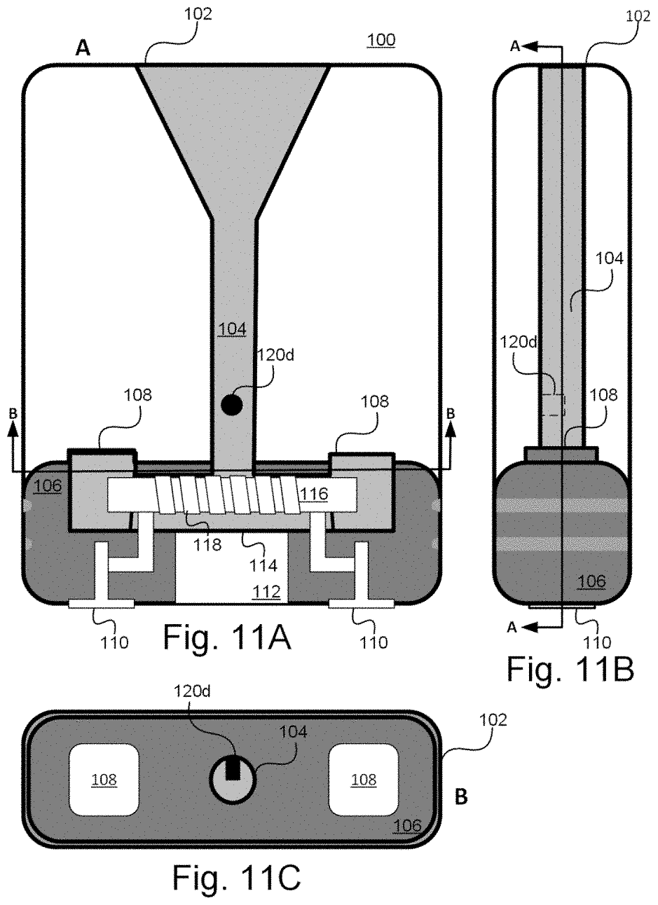

FIGS. 11A 11B and 11C illustrate an alternate embodiment of pod 100, and are similar in structure and description to the pod 100 shown in FIGS. 5A 5B and 5C. Vortex generator 120d in FIGS. 11A 11B and 11C differs from vortex generator 120a shown in FIGS. 5A 5B and 5C in that it does not fully span the width of the post wick air flow passage 104. This shorter length of the vortex generator 120d may provide a smaller surface on which condensation can form. In some embodiments a shorter length of the vortex generator may also act as a characteristic that has an effect on the characteristics of generated vortices, and thus on the threshold droplet size.

Although illustrated in the above figures as being level with the wick, or perpendicular to the walls of the post wick air flow passage, it should be understood that in other embodiments, the vortex generator may be angled with respect to either the wick or the walls of the post wick air flow passage. This may result in a longer vortex generator with a shorter effective length in profile which may influence the characteristics of the generated vortices.

As noted above, the sizes provided in the drawings are provided for exemplary purposes and should not be considered limiting of the scope of the invention, which is defined solely in the claims.

1. A pod for storing an atomizable liquid, the pod comprising:
a reservoir for storing the atomizable liquid;
a wick for drawing the atomizable liquid into an atomization chamber within an air flow path; and
a vortex generator located within the air flow path for interrupting laminar air flow within the air flow path and for generating a vortex in a post wick air flow passage.

2. The pod of claim 1 wherein the liquid is an e-liquid comprising at least one of propylene glycol, vegetable glycerin, nicotine and a flavoring.

3. The pod of claim 1 wherein the air flow path comprises a pre-wick air flow passage, the atomization chamber and the post wick air flow passage.

4. The pod of claim 1 wherein the post wick air flow passage is configured to carry an airflow comprising entrained droplets of the atomizable liquid.

5. The pod of claim 4 wherein the post wick air flow passage is further configured to carry a vortex within the airflow.

6. The pod of claim 5 wherein the vortex generator is configured to generate the vortex to remove entrained droplets above a threshold size from the airflow in the post wick air flow passage.

7. The pod of claim 6 wherein the threshold size is determined in accordance with physical characteristics of the vortex generator.

8. The pod of claim 1 wherein the vortex generator is one of a cylinder, a rectangular rod and a set of blades.

9. The pod of claim 8 wherein the post wick air flow passage is configured to carry an airflow comprising a Kàrmàn street vortex.

10. The pod of claim 1 wherein the vortex generator is located within the post wick air flow passage.

11. The pod of claim 10 wherein the vortex generator is located within a resilient top cap.

12. The pod of claim 11 wherein the resilient top cap is comprised of silicone.

13. The pod of claim 10 wherein the vortex generator is rotated about a central axis of the post wick air flow passage with respect to the wick.

14. The pod of claim 1 wherein the vortex generator is parallel to the wick.
